(19) United States
(12) Patent Application Publication
(10) Pub. No.: US 2008/0292390 A1
(43) Pub. Date: Nov. 27, 2008

(54) GOOSENECK COUPLER HAVING AN ANTI-RATTLE DEVICE

(76) Inventors: Todd Walstrom, Weston, WI (US); Kevin Rabska, Junction City, WI (US); Frank Drake, Wausau, WI (US)

Correspondence Address: MCDONALD HOPKINS LLC, 600 Superior Avenue, East, Suite 2100, CLEVELAND, OH, 44114-2653, US

(21) Appl. No.: 11/752,450

(22) Filed: May 23, 2007

(51) Int. Cl. B60D 1/40

(52) U.S. Cl. 403/109.6; 280/479.3

(57) ABSTRACT

A coupler includes a first telescopic member having a first pair of coaxially aligned apertures, and a second telescopic member having a second pair of coaxially aligned apertures. The second pair of apertures is capable of coaxial alignment with the first pair of apertures during telescopic engagement between the first and second telescopic members. A pin member having a head is capable of insertion through the coaxially aligned first and second pairs of apertures. At least one of the second apertures is sized to receive the head therethrough to engage the first telescopic member.

### FIELD OF THE INVENTION

This invention relates to a coupler for securing a trailer to a towing vehicle, and more particularly to a gooseneck coupler having an anti-rattle device.

### BACKGROUND

With the increased popularity of recreational vehicles, manufacturers are designing and building vehicles of varying proportions and features. While many recreational vehicles, or trailers, continue to be hitched to the rear end of a towing vehicle through a coupler on the trailer and a hitch on the towing vehicle, larger vehicles have been developed which include a portion extending over the back of the towing vehicle. Examples of such large vehicles include fifth wheel trailers which couple to a specialized hitch mounted within the bed of a pick-up truck and trailers incorporating a gooseneck coupler that is secured to a ball mounted inside the pickup truck bed, usually directly over the rear axle.

Typically, a gooseneck coupler includes a pair of telescoping tubes with a first tube being fixedly secured to a towing vehicle and the second tube being fixedly secured to a trailer. The first tube includes a pair of coaxially aligned apertures. Similarly, the second tube includes a pair of coaxially aligned apertures. The second tube telescopically slides over the first tube until the apertures of the second tube are in coaxial alignment with the apertures of the first tube or visa-versa. A cross-pin is then disposed through both pairs of apertures to couple the first and second tubes to one another thereby releasably coupling the trailer to the towing vehicle. The cross-pin may be held into place by a fastener such as a nut, cotter pin, or the like.

In use, the towing vehicle may encounter various road conditions, which may result in significant impact loading of the towing vehicle's rear axle that may be transferred through the vehicle's frame and associated componentry directly to the gooseneck coupler. This impact loading may cause elongation of one or both pairs of tube apertures. Over time, the elongation of these apertures will make it increasingly difficult to align and insert the cross-pin therethrough. In addition, portions of the tubes surrounding the apertures may crack, which may lead to tube fracture and failure. Moreover, the impact loading may cause cross-pin deformation, making it increasingly difficult to insert and remove the cross-pin from the apertures, and, over time, the cross-pin may fracture resulting in damage to the gooseneck coupler, towing vehicle, trailer and cargo.

Consequently, there exists a significant need for a more durable gooseneck coupler, which will better handle imposed vertical impact loading, and which will be relatively simple and cost effective to produce.

### SUMMARY OF THE INVENTION

An embodiment of the present invention provides for a coupler. The coupler includes a first telescopic member having a first pair of coaxially aligned apertures, and a second telescopic member having a second pair of coaxially aligned apertures. The second pair of apertures is capable of coaxial alignment with the first pair of apertures during telescopic engagement between the first and second telescopic members. A pin member having a head is capable of insertion through the coaxially aligned first and second pairs of apertures. At least one of the second apertures is sized to receive the head there through to engage the first telescopic member.

### BRIEF DESCRIPTION OF THE DRAWINGS

The present invention will be more fully understood by reference to the following detailed description of a preferred embodiment of the present invention when read in conjunction with the accompanying drawings, in which like reference characters refer to like parts throughout the views and in which:

FIG. 1 is a perspective view of a towing vehicle connected to a trailer incorporating an adjustable gooseneck coupler embodying the present invention;

FIG. 2 is a partial perspective view of the gooseneck coupler;

FIG. 3 is a cross-sectional view taken along lines 3-3 of FIG. 2;

FIG. 4 is a partial first side view of the gooseneck coupler without a cross-pin inserted into the apertures; and

FIG. 5 is a partial second side view of the gooseneck coupler with a cross-pin inserted into the apertures.

### DETAILED DESCRIPTION

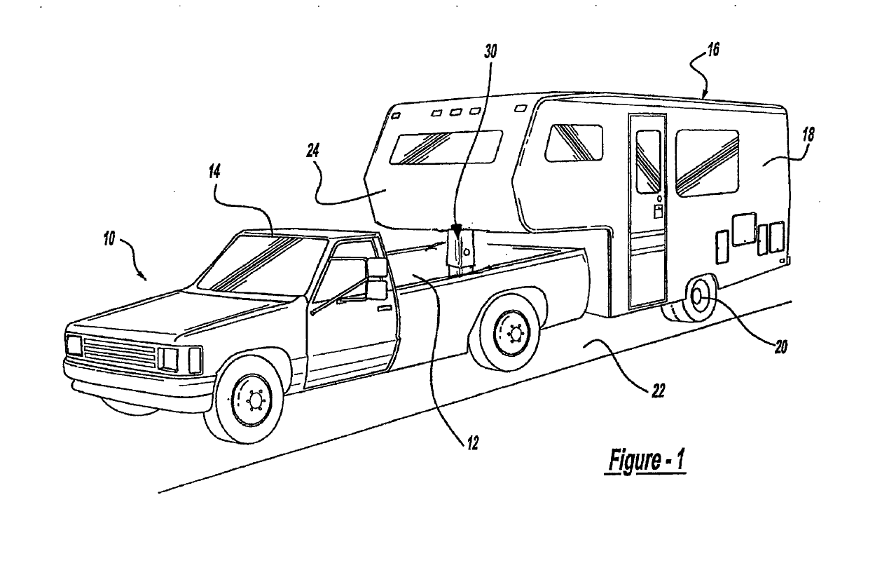

Referring first to FIG. 1, there is shown a towing vehicle 10, such as a pick-up truck having a cargo bed 12 and a passenger cab 14, and a trailer 16 adapted to be towed by the vehicle 10. The trailer 16 may include a housing compartment 18 supported on at least one set of wheel axles 20 to roll along the road 22. The trailer 16 may also have an overhanging portion 24 which extends above the truck cargo bed 12 when the vehicles 10 and 16 are coupled; however it will be understood that the trailer 16 may not necessarily include an overhanging portion. The truck bed 12 may include a hitch ball or similar structure for detachably receiving a gooseneck coupler 30 in accordance with the present invention. Also, it will be appreciated that the gooseneck coupler 30 may be coupled to the towing vehicle 10 in a location other than the truck bed.

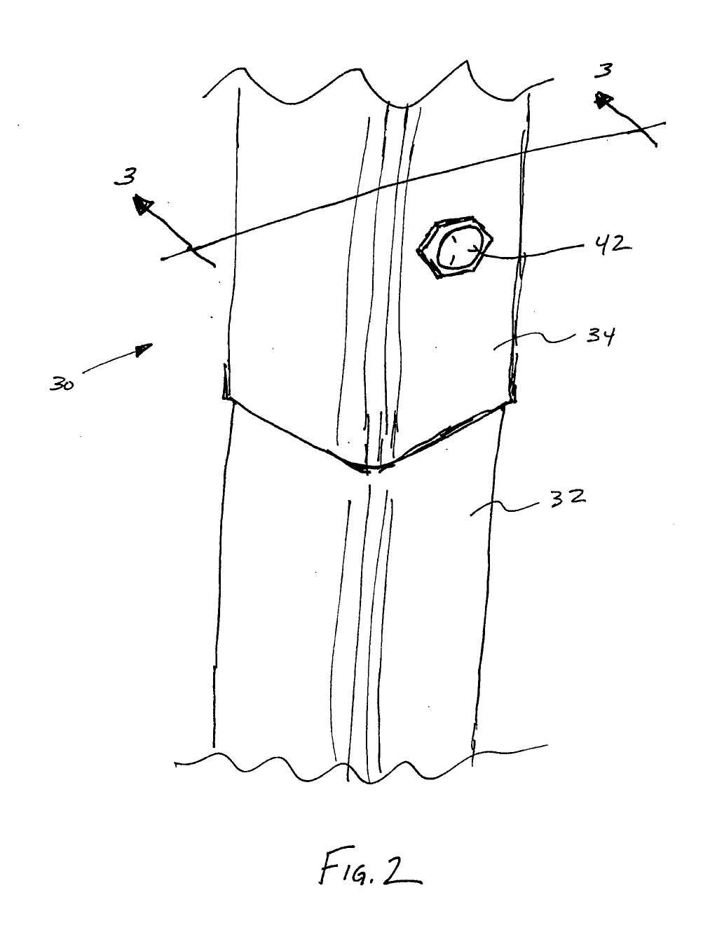

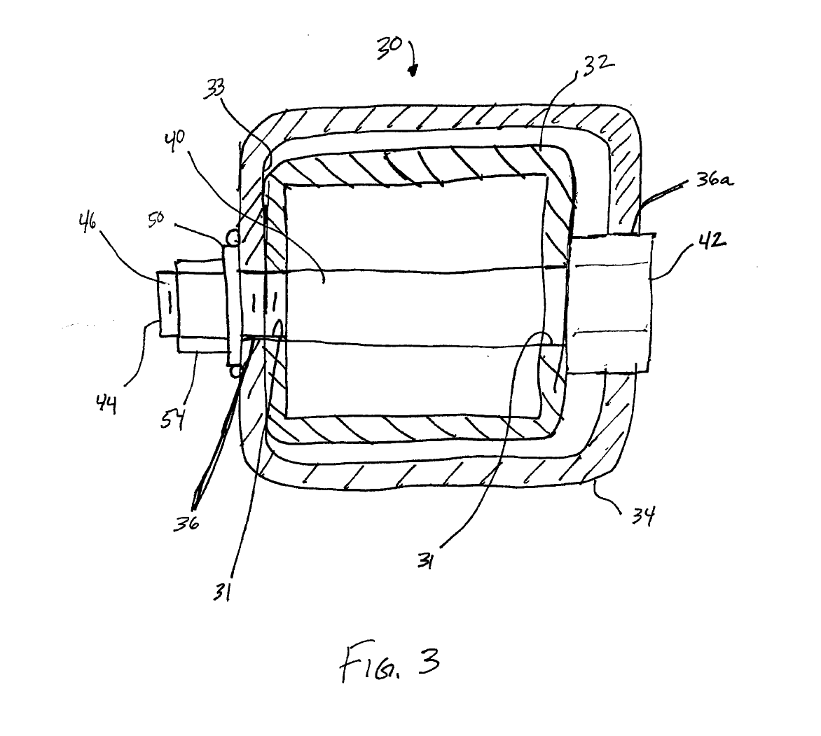

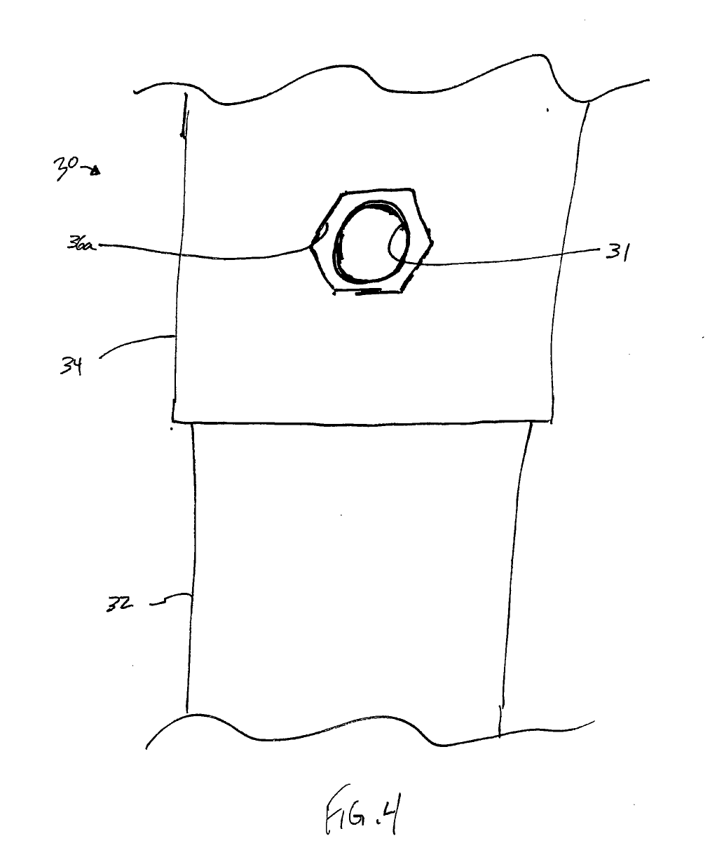

Referring now FIGS. 2 through 5, the gooseneck coupler 30 includes a pair of telescoping tubes—an inner tube 32 and outer tube 34. The inner tube 32 may be releasably coupled to the towing vehicle 10, typically within the truck bed 12; alternatively, the inner tube 32 may be fixedly secured to the trailer 16, typically the underside of the trailer overhang 24. As best shown in FIG. 3, the inner tube 32 may include a pair of coaxially aligned apertures 31. While the inner tube 32 is shown having a substantially square cross-section, it will be appreciated that any suitable cross-section may be employed, including but not limited to circular, triangular, rectangular, hexagonal, or the like. In addition, while the inner tube 32 is shown as having a substantially hollow cross-section, it will be understood that the inner tube 32 may have a substantially solid cross-section.

The outer tube 34 may be fixedly secured to the trailer 16, typically the underside of the trailer overhang 24; alternatively, the outer tube 34 may be releasably coupled to the towing vehicle 10, typically within the truck bed 12. As best shown in FIG. 3, the outer tube 34 may include a pair of coaxially aligned apertures 36 and 36a. In one embodiment, the first aperture 36a is larger in diameter than the second aperture 36 and is sized to receive a head 42 of a cross-pin such that the head 42 maybe drawn into the first aperture 36a. The first aperture 36a and head 42 may have complimentarily shaped cross-sections such that engagement of the head 42 within the aperture 36a prevents rotation of the cross-pin 40. For example, the first aperture 36a may have a triangular cross-section, square cross-section, hexagonal cross-section, circular cross-section, or the like.

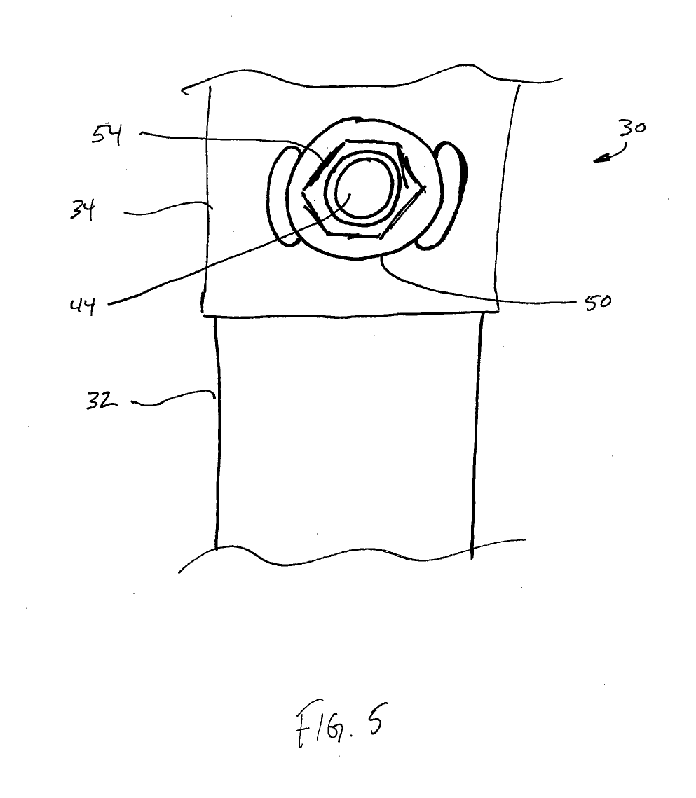

Additionally, the outer tube 34 may be reinforced about the second aperture 36 to distribute load from a nut 54, or other similar fastener, situated about the second aperture 36. For example, in one embodiment as illustrated in FIGS. 3 and 5, a washer 50 may be welded on an exterior surface of the outer tube 34 and in alignment with the second aperture 36 to distribute load from a nut 54 situated about the second aperture 36. Further, while the outer tube 34 is shown having a substantially square cross-section, it will be appreciated that any suitable cross-section may be employed, including but not limited to circular, triangular, rectangular, hexagonal, or the like.

A cross-pin 40 may be used to couple the inner tube 32 and outer tube 34 together. The cross-pin 40 may have any suitable cross-section such that the cross-pin 40 may extend through both pairs of apertures 36, 36a and 31 and washer 50. For example, the cross-pin 40 may have a circular cross-section, square cross-section, triangular cross-section, hexagonal cross-section, or the like. The cross-pin 40 may include a head 42. In one embodiment, the head 42 is located at a trailing end of the cross-pin 40; alternatively, the head 42 may be located on the cross-pin 40 between a trailing and a leading end 44. As previously mentioned, the first aperture 36a and head 42 may have complimentarily shaped cross-sections such that engagement of the head 42 within the aperture 36a prevents rotation of the cross-pin 40. For example, the head 42 may have a triangular cross-section, square cross-section, hexagonal cross-section, or the like.

The cross-pin 40 may also include a threaded portion 46 for threadably receiving a nut 54. In one embodiment, the threaded portion 46 is located at a leading end 44 of the cross-pin 40; alternatively, the threaded portion 46 may be located on the cross-pin 40 between a trailing end and a leading end 44. A nut 54 may threadably engage the threaded portion 46 to partially draw the cross-pin 40 through the apertures 36, 36a and 31 as well as hold the cross-pin 40 in place. However, it will be appreciated that any suitable fastener, such as a cotter pin or the like, may be used to hold the cross-pin 40 in place.

In use, the outer tube 34 and inner tube 32 are telescopically engaged whereby both pairs of apertures 36, 36a and 31 are coaxially aligned. The cross-pin 40 is inserted through both pairs of apertures 36, 36a and 31 such that the head 42 is received by the first aperture 36a and such that a leading end 44 extends through the second aperture 36 and washer 50. The nut 54 is threadably engaged with the threaded portion 46 of the cross-pin 40.

Rotation of the nut 54 in a first direction will cause the cross-pin 40 to move radially inwardly such that the head 42 is drawn into the first aperture 36a to engage and bias the inner tube 32 against an opposing interior side 33 of the outer tube 34 thereby providing substantial normal and frictional forces between the outer 34 and inner 32 tubes. These normal and frictional forces act to maintain the inner tube 32, both positionally and rotationally, within the outer tube 34. Consequently, impact forces may be transferred to the outer tube 34, not only through direct bearing of the cross-pin 40, but also through the normal and frictional contact between the outer tube 34 and inner tube 32 thereby reducing the amount of impact transferred to the apertures 36, 36a and 31 and cross-pin 40. Rotation of the nut 54 in a second opposite direction will cause the cross-pin 40 to move radially outwardly such that the head 42 is drawn away from the inner tube 32 thereby disengaging the inner tube 32 from the interior side 33 of the outer tube 34.

Having shown and described the preferred embodiment, further adaptations of the methods and systems described herein may be accomplished by appropriate modifications by one of ordinary skill in the art without departing from the scope and principles of the present invention. Several potential modifications will become apparent to those skilled in the art. Accordingly, the scope of the present invention should be considered in terms of the following claims and is understood not to be limited to the details of the embodiment shown and described above.

1. A coupler comprising:
a telescopic assembly coupled on a first end to a towing vehicle and coupled on a second end to a towed vehicle, said second end disposed substantially vertically above said first end, said telescopic assembly comprising:
a first telescopic member having a first pair of coaxially aligned apertures; and
a second telescopic member having a second pair of coaxially aligned apertures capable of coaxial alignment with said first pair of apertures during telescopic engagement with said first telescopic member;
a pin member capable of insertion through said coaxially aligned first pair of apertures and second pair of apertures, said pin member comprising:
a head sized to be received by at least one of said second pair of apertures to directly engage said first telescopic member; and
a threaded portion; and
a threaded nut capable of providing a force to bias said first telescopic member against said second telescopic member when said nut is engaged with said threaded portion of pin, where a magnitude of said force resists a transfer of vertical impact forces from said towing vehicle or said towed vehicle to said pin.

2. (canceled)

3. The coupler of claim 1 wherein said head is located on a first end of said pin member.

4. The coupler of claim 3 wherein said threaded portion is located on a second end of said pin member.

5. The coupler of claim 1 wherein said head and at least one of said second pair of apertures have complimentarily shaped cross-sections wherein engagement between said head and said at least one of said second pair of apertures prevents pin member rotation.

6. The coupler of claim 5 wherein each of said complimentarily shaped cross-sections is polygonal.

7. The coupler of claim 6 wherein each of said complimentarily shaped cross-sections is hexagonal.

8. A coupler comprising:
a telescopic assembly coupled on a first end to a towing vehicle and coupled on a second end to a towed vehicle, said second end disposed substantially above said first end, said telescopic assembly comprising:
a telescopic member having a first pair of coaxially aligned apertures; and
a tube having a second pair of coaxially aligned apertures capable of coaxial alignment with said first pair of apertures during telescopic engagement with said telescopic member;
a pin member capable of insertion through said coaxially aligned first pair of apertures and second pair of apertures, said pin member comprising
a head sized to be received by at least one of said second pair of apertures to directly engage said telescopic member; and
a threaded portion; and
a threaded nut capable of providing a force to bias said telescoping member against said tube when said nut is engaged with said threaded portion of pin, where a magnitude of said force resists a transfer of vertical impact force from said towing vehicle or said towed vehicle to said pin.

9. (canceled)

10. The coupler of claim 8 wherein said head is located on a first end of said pin member.

11. The coupler of claim 10 wherein said threaded portion is located on a second end of said pin member.

12. The coupler of claim 8 wherein said head and at least one of said second pair of apertures have complimentarily shaped cross-sections wherein engagement between said head and said at least one of said second pair of apertures prevents pin member rotation.

13. The coupler of claim 12 wherein each of said complimentarily shaped cross-sections is polygonal.

14. The coupler of claim 13 wherein each of said complimentarily shaped cross-sections is hexagonal.

15. The coupler of claim 1 wherein said first telescopic member is a tube.

16. The coupler of claim 1, further comprising a washer positioned between said nut and said second telescoping member when said nut is engaged with said threaded portion of pin.

17. The coupler of claim 16, where said washer is secured to said second telescopic member proximate to one of said second pair of apertures.

18. The coupler of claim 1, where said force biasing said first telescopic member against said second telescopic member results from the engagement of the nut with the threaded portion of pin placing said pin in tension.

19. The coupler of claim 1, where said first telescopic member is a solid tube.

20. The coupler of claim 8, further comprising a washer positioned between said nut and said tube when said nut is engaged with said threaded portion of pin.

21. The coupler of claim 20, where said washer is secured to said tube proximate to one of said second pair of apertures.

22. The coupler of claim 8, where said force biasing said telescopic member against said tube results from the engagement of the nut with the threaded portion of pin placing said pin in tension.
